(19) United States
(12) Patent Application Publication
(10) Pub. No.: US 2015/0259191 A1
(43) Pub. Date: Sep. 17, 2015

(54) BUCKLE ASSEMBLY FOR A STIRRUP STRAP

(71) Applicant: Jimmy R. Rider, Minco, OK (US)

(72) Inventor: Jimmy R. Rider, Minco, OK (US)

(21) Appl. No.: 14/642,403

(22) Filed: Mar. 9, 2015

Related U.S. Application Data
(60) Provisional application No. 61/950,975, filed on Mar. 11, 2014.
(60) Provisional application No. 61/973,546, filed on Apr. 1, 2014.

(51) Int. Cl. B68C 1/16; A44B 11/25; A44B 11/22

(52) U.S. Cl. CPC B68C 1/16; A44B 11/22; A44B 11/2592

(57) ABSTRACT

A buckle assembly for a stirrup strap is disclosed, one aspect comprising a plate connectable to a first end of the strap, the plate having a tongue extendable from the first end of the strap, the tongue having at least one pin extending perpendicularly from the first side, the pin being insertable in a strap through-hole near a second end thereof; and a receiver having a sleeve with a first side and a second side, the sleeve being configured to slidably receive the second end of the stirrup strap and the tongue when the pin of the first side of the tongue is positioned in one of the through-holes, the receiver further having a spring latch with a distal end having an opening for receiving the pin, the spring latch moveable between a locking position and a release position.

### CROSS-REFERENCE TO RELATED APPLICATIONS

This application claims priority to U.S. Provisional Application Ser. No. 61/950,975, filed on Mar. 11, 2014, entitled “BUCKLE ASSEMBLY FOR A STIRRUP STRAP”, and U.S. Provisional Application Ser. No. 61/973,546, filed on Apr. 1, 2014, entitled “BUCKLE ASSEMBLY FOR A STIRRUP STRAP”, the entire contents of each of which are hereby expressly incorporated herein by reference.

### BACKGROUND

Equestrian tack is generally adjustable to accommodate riders of different sizes. For example, the length of the stirrups are adjustable to correspond to the length of the rider's leg so that the rider may use the stirrup and corresponding stirrup strap to stabilize the rider's position in the saddle. The length of the stirrup strap is typically secured in a desired position with a buckle assembly. A problem encountered with existing buckle assemblies is that they have a tendency to release when subjected to forces created by movements of horse and rider. Failure of the buckle assembly may cause the rider to loose balance or even fall from the horse, thereby resulting in injury to the rider, and possibly the horse.

To this end, a need exists for an improved apparatus for adjusting and locking a stirrup strap of a saddle. It is to such apparatus that the inventive concepts disclosed herein are directed.

### BRIEF DESCRIPTION OF THE DRAWINGS

The accompanying drawings, which are incorporated in and constitute a part of this specification, illustrate one or more implementations described herein and, together with the description, explain these implementations.

FIG. 1 is a partially cutaway, perspective view of a saddle shown with a stirrup strap secured with a buckle assembly constructed in accordance with the inventive concepts disclosed herein and shown.

FIG. 2 is a rear perspective view of the stirrup strap of FIG. 1 shown with the buckle assembly in a release position.

FIG. 3 is a front perspective view of the buckle assembly of FIG. 1.

FIG. 4 is a side elevational view of a plate of the buckle assembly of FIG. 3.

FIG. 5 is a cross-sectional view of the buckle assembly shown attached to the stirrup strap and in a locking position.

FIG. 6 is a cross-sectional view of the buckle assembly shown attached to the stirrup strap and in the release position.

FIG. 7 is a perspective view of another embodiment of a buckle assembly constructed in accordance with the inventive concepts disclosed herein

FIG. 8 is a side elevational view of a plate of the buckle assembly of FIG. 7.

FIG. 9 is a perspective view of another embodiment of a buckle assembly constructed in accordance with the inventive concepts disclosed herein.

FIG. 10 is a side elevational view of a plate of the buckle assembly of FIG. 9.

FIG. 11 is a cross-sectional view of the buckle assembly of FIG. 9 shown attached to a stirrup strap and in a locking position.

FIG. 12 is a cross-sectional view of the buckle assembly of FIG. 9 shown attached to the stirrup strap and in a release position.

FIG. 13 is a perspective view of another embodiment of a buckle assembly constructed in accordance with the inventive concepts disclosed herein.

FIG. 14 is a side elevational view of a plate of the buckle assembly of FIG. 13.

FIG. 15 is a cross-sectional view of the buckle assembly of FIG. 13 shown attached to a stirrup strap and in a locking position.

FIG. 16 is a cross-sectional view of the buckle assembly of FIG. 13 shown attached to the stirrup strap and in a release position.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments, or of being practiced or carried out in various ways. Also, it is to be understood that the phraseology and terminology employed herein is for the purpose of description and should not be regarded as limiting the inventive concepts disclosed and claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” and any variations thereof, are intended to cover a non-exclusive inclusion. For example, a process, method, article, or apparatus that comprises a list of elements is not necessarily limited to only those elements, and may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B is true (or present).

In addition, use of the “a” or “an” are employed to describe elements and components of the embodiments disclosed herein. This is done merely for convenience and to give a general sense of the inventive concepts. This description should be read to include one or at least one and the singular also includes the plural unless it is obvious that it is meant otherwise.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

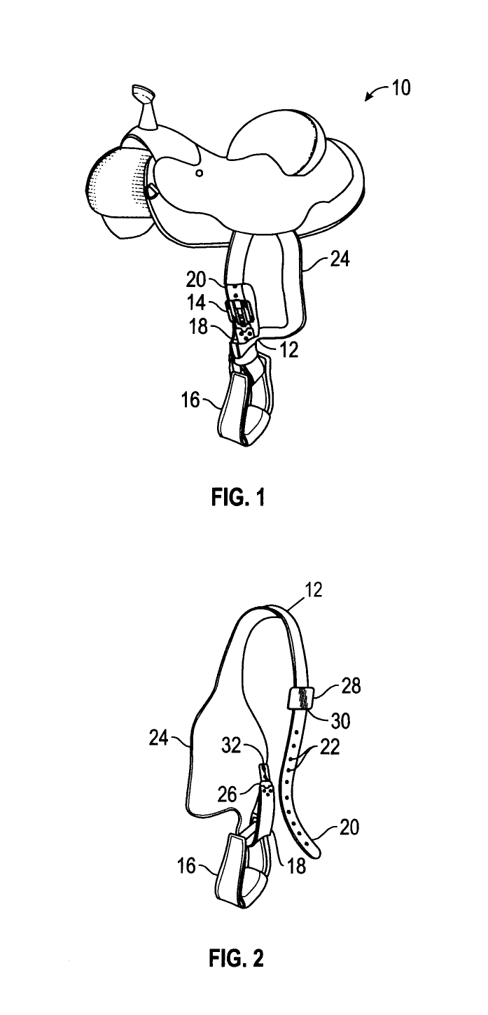

Referring now to the drawings, and more particularly to FIG. 1, a saddle 10 is illustrated in conjunction with a stirrup strap 12 which is secured to the saddle 10 with a buckle assembly 14 constructed in accordance with the inventive concepts disclosed herein. The saddle 10 depicted in FIG. 1 is commonly known as a western style saddle. However, it will be understood that the buckle assembly 14 is applicable to other types of saddles and need not be limited to western style saddles. For clarity, the saddle 10 of FIG. 1 is shown in simplified form, without rigging and components typically present, showing one stirrup 16 supported by the stirrup strap 12, and with a partial cutaway of the stirrup strap 12 to more clearly illustrate the buckle assembly 14. FIG. 2 shows a rear perspective view of the stirrup strap 12 disconnected from the saddle 10.

As illustrated in FIGS. 1 and 2, the stirrup strap 12 has a first end 18 and a second end 20. The second end 20 of the stirrup strap 12 is movably attached to the saddle 10 and extends from the saddle 10. The stirrup strap 12 has a plurality of through-holes 22 extending through the stirrup strap 12 near the second end 20 of the stirrup strap 12. The second end 20 is connectable to the first end 18. The stirrup strap 12 may have a wider intermediate portion, commonly known as a fender 24, between the first end 18 and the second end 20. The stirrup strap 12 is typically made of leather, synthetic materials, and/or a combination of materials. The stirrup strap 12 may be made of one or more than one layer and/or one or more joined portions of material and may have differing thicknesses.

As illustrated in FIGS. 1-6, the buckle assembly 14 may include a plate 26 connectable to the first end 18 of the stirrup strap 12 and a receiver 28 having a sleeve 30 configured to slideably receive the second end 20 of the stirrup strap 12.

The plate 26 has a tongue 32 which extends from the first end 18 of the stirrup strap 12 when the plate 26 is connected to the stirrup strap 12. The tongue 32 has a first side 34 and a second side 36. The tongue 32 also has at least one pin 38 extending substantially perpendicularly from the first side 34 and at least one pin 40 extending substantially perpendicularly from the second side 36. The pin 38 of the first side 34 is insertable in a least one of the plurality of through-holes 22 extending through the stirrup strap 12 near the second end 20 of the stirrup strap 12.

FIGS. 2 and 4 illustrate one aspect of the present disclosure in which the tongue 32 has two pins 38 extending from the first side 34. One of the pins 38 may be an extension of the pin 40 extending from the second side 36 of the tongue 32.

The sleeve 30 of the receiver 28 is configured to slideably receive the tongue 32 when the pin 38 of the first side 34 of the tongue 32 is positioned in one of the through-holes 22 of the stirrup strap 12. The sleeve 30 has been shown as encompassing the stirrup strap 12, however, it will be appreciated that the sleeve 30 may be formed in other configurations, such as C shaped, so long as the sleeve 30 remains secured to the stirrup strap 12.

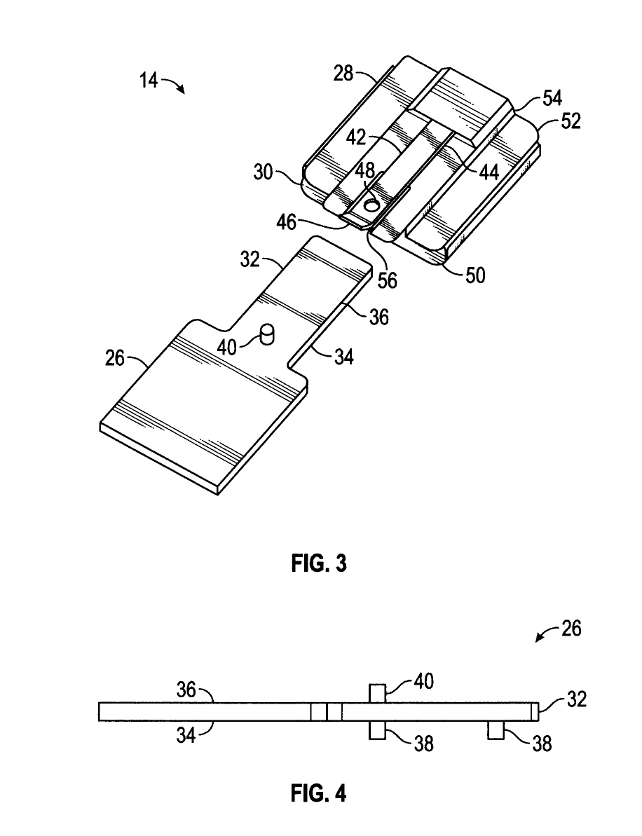

As shown in FIG. 3, the receiver 28 has a spring latch 42 with a proximal end 44 and a distal end 46. The distal end 46 has an opening 48 for receiving the pin 40 of the second side 36 of the tongue 32. The spring latch 42 may be formed of any suitable durable material, such as spring steel.

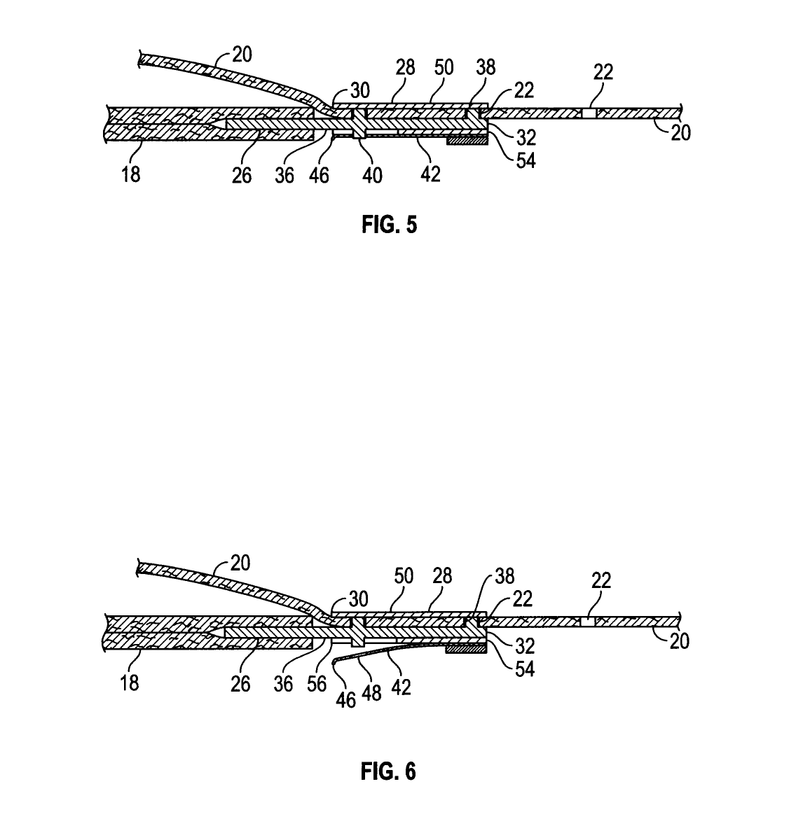

The spring latch 42 extends from the sleeve 30 in a way that the spring latch 42 is moveable between a locking position (FIG. 5) and a release position (FIG. 6). In the locking position, the distal end 46 of the spring latch 42 is biased to receive the pin 40 of the second side 36 of the tongue 32 in the opening 48 when the pin(s) 38 of the first side 34 is inserted in one of the through-holes 22. In the release position, the distal end 46 of the spring latch 42 is deflected away from the pin 40 of the second side 36 of the tongue 32 so as to permit the receiver 28 to slide relative to the tongue 32.

The spring latch 42 may be attached to the sleeve 30 in any suitable manner, non-exclusive examples of which include spot welding, riveting, pressing, and bending. Alternatively and/or additionally, the spring latch 42 may be formed as a whole with the sleeve 30.

As shown in FIGS. 3, 5, and 6, the sleeve 30 has a first side 50 and a second side 52 with a raised longitudinal channel 54 configured to receive the tongue 32 on the second side 52 of the sleeve 30. In one embodiment, the second side 52 of the sleeve 30 has a guide slot 56 for receiving the pin 40 as the sleeve 30 slideably receives the tongue 32. The spring latch 42 is positioned on the second side 52 of the sleeve 30 so as to extend into the guide slot 56.

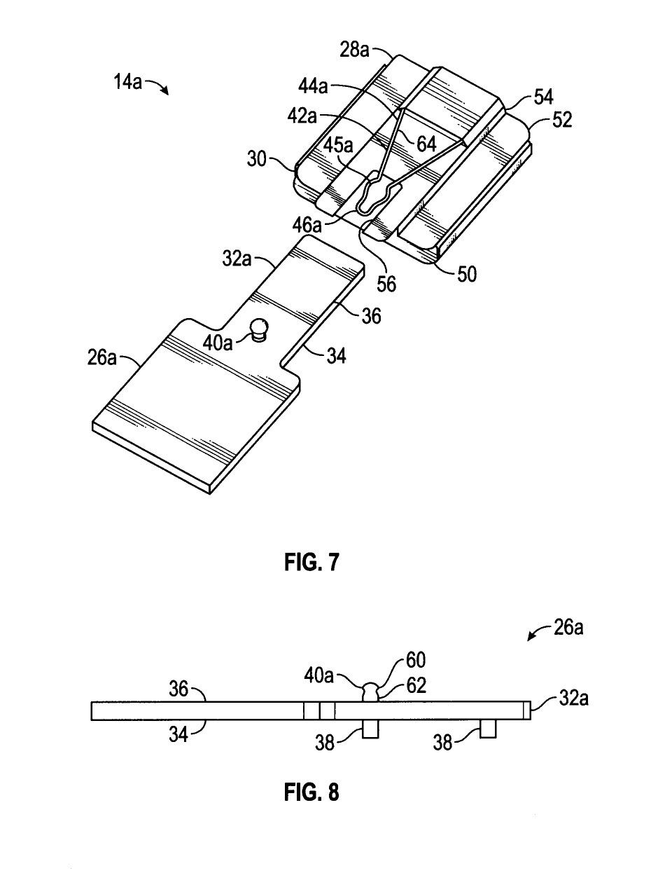

FIGS. 7 and 8 show another embodiment of a buckle assembly 14a constructed in accordance with the inventive concepts disclosed herein. The buckle assembly 14a is substantially similar to the buckle assembly 14, except as described herein below. The buckle assembly 14a includes a plate 26a connectable to the first end 18 of the stirrup strap 12 and a receiver 28a having a sleeve 30 configured to slideably receive the second end 20 of the stirrup strap 12. The plate 26a has a tongue 32a extending from the first end 18 of the stirrup strap 12 when the plate 26a is connected to the stirrup strap 12. The tongue 32a has a first side 34 and a second side 36. The tongue 32a has at least one pin 38 extending substantially perpendicularly from the first side 34 and at least one pin 40a extending substantially perpendicularly from the second side 36. The pin 38 of the first side 34 is insertable in a least one of a plurality of through-holes 22 extending through the stirrup strap 12 near the second end 20 of the stirrup strap 12. The pin 40a extending from the second side 36 of the tongue 32a has a substantially rounded top portion 60 and a neck portion 62 narrower than the rounded top portion 60.

The receiver 28a of buckle assembly 14a has a spring latch 42a comprised of a flexible wire 64. The spring latch 42a has a proximal end 44a and a distal end 46a with the distal end 46a forming an opening 48a. The opening 48a has a narrower width than the top portion 60 of the pin 40a such that the flexible wire 64 forming the opening 48a is expandable to allow the opening 48a to pass over the top portion 60 to the neck portion 62.

The spring latch 42a extends from the sleeve 30 in a way that the spring latch 42a is moveable between a locking position and a release position similar to that described above in reference to the buckle assembly 14. When the sleeve 30 slideably receives the tongue 32, the distal end 46a of the spring latch 42a receives the top portion 60 then the neck portion 62 of the pin 40a in the opening 48a, thereby locking the wider top portion 60 in the spring latch 42a in the locking position. To reach the release position, the distal end 46a of the spring latch 42a is deflected away from the pin 40a and the opening 48a expands to release the pin 40a so as to permit the receiver 28 to slide relative to the tongue 32.

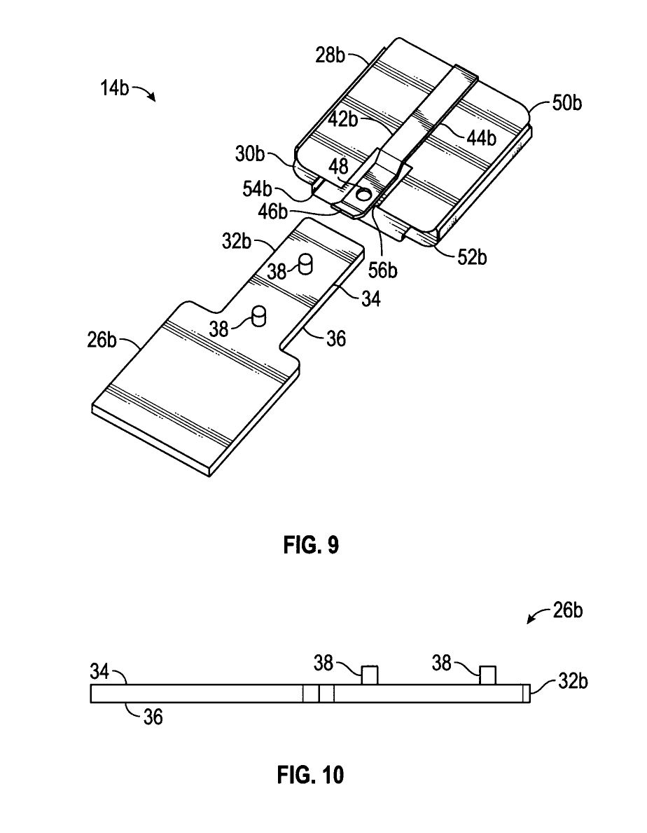

FIGS. 9-12 show another embodiment of a buckle assembly 14b constructed in accordance with the inventive concepts disclosed herein. The buckle assembly 14b is similar to the buckle assembly 14 described above, except as described herein below. The buckle assembly 14b includes a plate 26b connectable to the first end 18 of the stirrup strap 12 and a receiver 28b having a sleeve 30b configured to slideably receive the second end 20 of the stirrup strap 12. The plate 26b has a tongue 32b extending from the first end 18 of the stirrup strap 12 when the plate 26b is connected to the stirrup strap 12. The tongue 32b has a first side 34 and a second side 36. In the buckle assembly 14b, the plate 26b has at least one pin 38 extending substantially perpendicularly from a first side 34. The length of the pin 38 may be greater than the thickness of the stirrup strap 12. The pin 38 of the first side 34 is insertable in a least one of the plurality of through-holes 22 extending through the stirrup strap 12 near the second end 20 of the stirrup strap 12. One or more additional pins 38 may extend substantially perpendicularly from the first side 34.

The sleeve 30b of the receiver 28b is configured to slideably receive the tongue 32b when the pins 38 of the first side 34 of the tongue 32b are positioned in the through-holes 22 of the stirrup strap 12. The sleeve 30b has a first side 50b and a second side 52b with the second side 52b having a channel 54b configured to receive the tongue 32b. In one embodiment, the first side 50b of the sleeve 30b is provided with a guide slot 56b to receive at least one of the pins 38.

The receiver 28b has a spring latch 42b with a proximal end 44b and a distal end 46b. The distal end 46b has an opening 48 for receiving the pin 38 extended through the through-hole 22 of the stirrup strap 12. The spring latch 42 is positioned on the first side 50b of the sleeve 30b with the distal end 46 extending into the guide slot 56b to allow the pin 38 to be received into the opening 48 as the sleeve 30b slideably receives the tongue 32b.

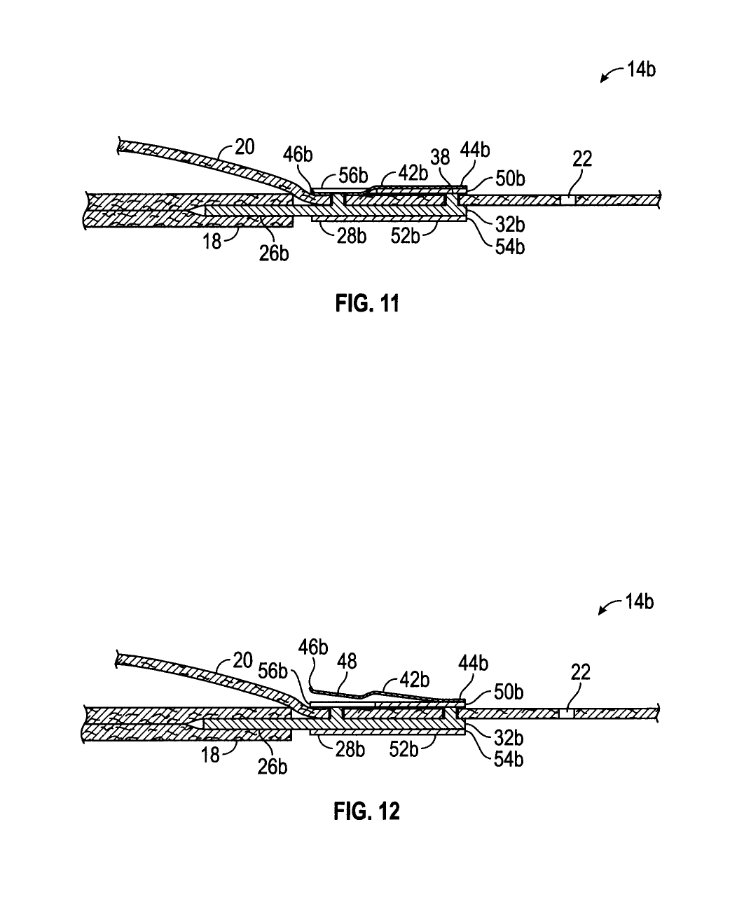

The spring latch 42b extends from the sleeve 30b in a way that the spring latch 42b is moveable between a locking position (FIG. 11) and a release position (FIG. 12). In the locking position, the distal end 46b of the spring latch 42b is biased to receive the pin 38 of the first side 34 of the tongue 32b in the opening 48 when the pins 38 of the first side 34 are inserted in the through-holes 22. In the release position, the distal end 46b of the spring latch 42b is deflected away from the pin 38 of the first side 34 of the tongue 32b so as to permit the receiver 28b to slide relative to the tongue 32b.

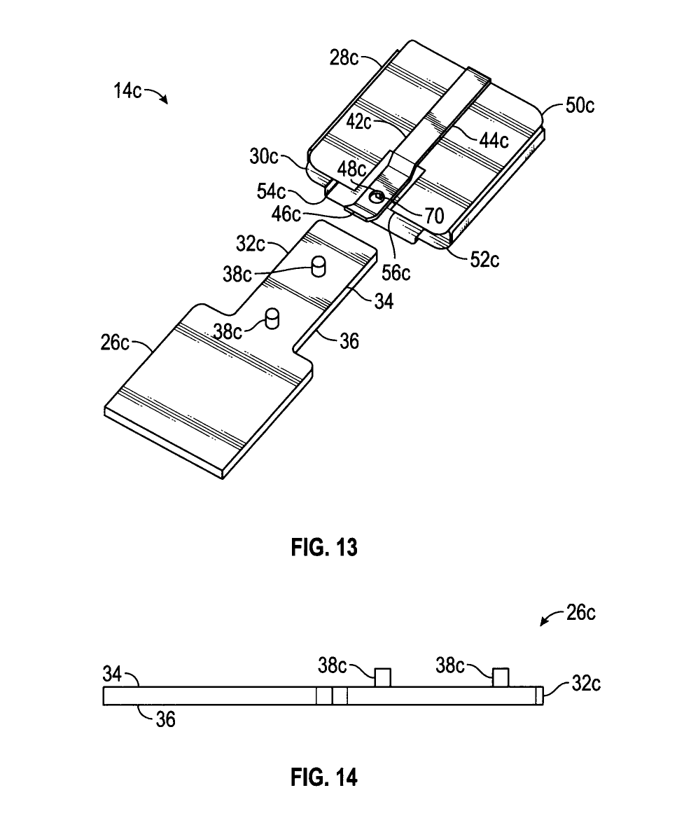

FIGS. 13-16 show another embodiment of a buckle assembly 14c constructed in accordance with the inventive concepts disclosed herein. The buckle assembly 14c is similar to the buckle assembly 14b described above, except as described herein below. The buckle assembly 14c includes a plate 26c connectable to the first end 18 of the stirrup strap 12 and a receiver 28c having a sleeve 30c configured to slideably receive the second end 20 of the stirrup strap 12. The plate 26c has a tongue 32c extending from the first end 18 of the stirrup strap 12 when the plate 26c is connected to the stirrup strap 12. The tongue 32c has a first side 34 and a second side 36. In the buckle assembly 14c, the plate 26c has at least one pin 38c extending substantially perpendicularly from a first side 34. The length of the pin 38c may be less than the thickness of the stirrup strap 12. The pin 38c of the first side 34 is insertable in a least one of the plurality of through-holes 22 extending through the stirrup strap 12 near the second end 20 of the stirrup strap 12. One or more additional pins 38c may extend substantially perpendicularly from the first side 34.

The sleeve 30c of the receiver 28c is configured to slideably receive the tongue 32c when the pins 38c of the first side 34 of the tongue 32c are positioned in the through-holes 22 of the stirrup strap 12. The sleeve 30c has a first side 50c and a second side 52c with the second side 52c having a channel 54c configured to receive the tongue 32c. In one embodiment, the first side 50c of the sleeve 30c is provided with a guide slot 56c to receive at least one of the pins 38c.

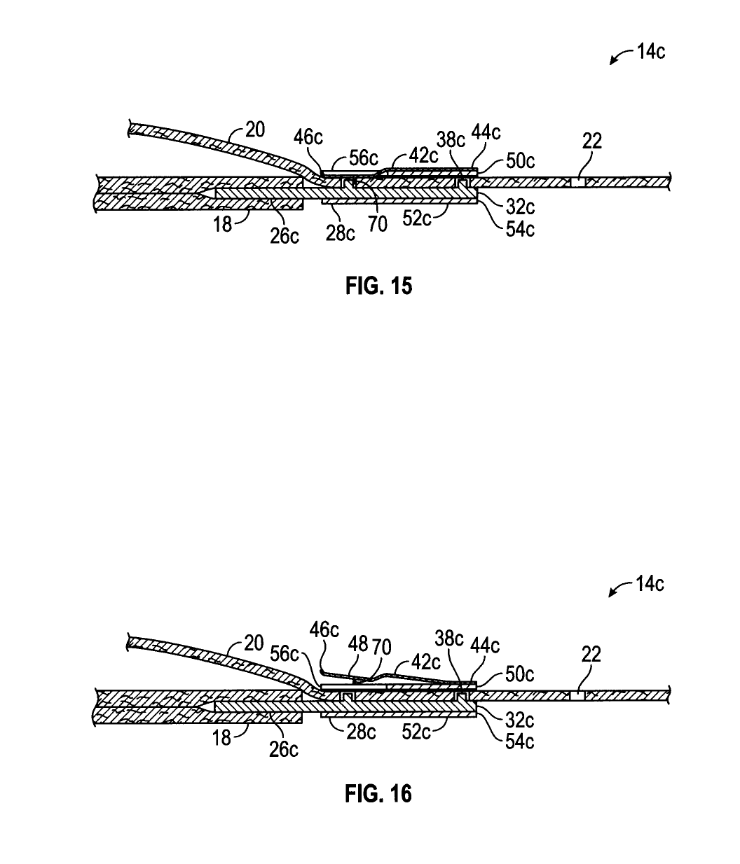

The receiver 28c has a spring latch 42c with a proximal end 44c and a distal end 46c. The distal end 46c may have an opening 48c. The distal end 46c has a barb 70 extending outward from the spring latch 42c. The spring latch 42c is positioned on the first side 50c of the sleeve 30c with the distal end 46c extending into the guide slot 56c to allow the barb 70 to fit between the pin 38c and a side of the through-hole 22 when the sleeve 30c slideably receives the tongue 32c. The barb 70 may extend substantially perpendicularly from the spring latch 42c, though it will be understood that the barb 70 may extend at an angle from the spring latch 42c, as long as the barb 70 is positionable between the pin 38c and a side of the through-hole 22. In embodiments with the opening 48c, the barb 70 may be positioned proximate to the opening 48c. In one embodiment, the spring latch 42c may not be provided with an opening and may include only the barb 70. The length of the spring latch 42c may be varied so long as the barb 70 may be positioned in a location between the pin 38c and the side of the through-hole 22. For example, in one embodiment the barb 70 may be positioned between the pin 38c and the through-hole on the opposite side of the pin 38c of that shown in FIG. 15.

The diameter of the pin 38c has been shown reduced relative to the diameter of the through-hole 22 for purposes of illustrating the barb 70 positioned between the pin 38c and the side of the through-hole 22. It will be understood that the diameter of the pin 38c and the diameter of the through-hole 22 may be substantially equal and that the barb 70 is configured to slide between the pin 38c and the side of the through-hole 22.

The spring latch 42c extends from the sleeve 30c in a way that the spring latch 42c is moveable between a locking position (FIG. 15) and a release position (FIG. 16). In the locking position, the distal end 46c of the spring latch 42c is biased such that the barb 70 is positioned in the through-hole 22 between the pin 38c and the side of the through-hole 22 when the pins 38 are inserted in the through-holes 22. In the release position, the barb 70 and the spring latch 42c are deflected away from the pin 38c and the through-hole 22 so as to permit the receiver 28c to slide relative to the tongue 32c.

It will be appreciated that the spring latch 42, 42a, 42b, 42c may be formed in a variety of ways, including but not limited to those shown in the figures herein. For example, the spring latch 42, 42a, 42b, 42c may be straight or may be bent to conform to the stirrup strap 12 or tongue 32 to facilitate engagement with pin 38 or 40.

The sleeve 30, 30b, 30c may be encompassed partially, or completely, with one or more materials (not shown). The material may protect the stirrup strap 12, the saddle 10, the horse, and/or the rider, from rubbing by the sleeve 30. Additionally, or alternatively, the material may be decorative. Non-exclusive exemplary materials include leather, neoprene, plastic, and rubber. The material may be the same material as the stirrup strap 12. The material may be attached to the sleeve 30, 30b, 30c by any suitable mechanism, including rivets and/or glue. Additionally, or alternately, the sleeve 30, 30b, 30c may be dipped or sprayed with the material.

The distal end 46, 46a, 46b, 46c of the spring latch 42, 42a, 42b, 42c may be coated with one or more protective material (not shown), non-exclusive examples of which include plastic and/or rubber.

Referring now to FIGS. 1-6, the method of securing the stirrup strap 12 using the buckle assembly 14 to a desired length will be described. A rider may deflect the spring latch 42 away from the pin 40 to the release position to permit the receiver 28 to slide relative to the tongue 32 (FIG. 6). The pin(s) 38 inserted in the through-holes 22 of the stirrup strap 12 may then be removed from the through-holes 22. The plate 26 may then be freely moved to different through-holes 22 on the second end 20 of the stirrup strap 12, thus shortening or lengthening the length of the stirrup strap 12.

Once the desired length is achieved, the pin(s) 38 are inserted into the desired through-holes 22. The receiver 28 is slideably moved along the stirrup strap 12 to engage the tongue 32. The distal end 46 of the spring latch 42 is deflected from the biased position to move over the pin 40 (FIG. 6) until the pin 40 is engaged in the opening 48 and the spring latch 42 returns to the locking position (FIG. 5).

From the above description, it is clear that the inventive concepts disclosed herein are well adapted to carry out the objects and to attain the advantages mentioned herein as well as those inherent in the inventive concepts disclosed herein. While exemplary embodiments of the inventive concepts disclosed herein have been described for purposes of this disclosure, it will be understood that numerous changes may be made which will readily suggest themselves to those skilled in the art and which are accomplished within the scope of the inventive concepts disclosed and claimed herein. For example, the through-holes 22 and the receiver 28 may be on the first end 18 of the stirrup strap 12 while the plate 26 may be on the second end 20 of the stirrup strap 12.

Additionally, while the buckle assembly 14 has been described in the context of a western style saddle stirrup strap 12, it will be understood the buckle assembly 14 may be used in conjunction with any strap requiring locking adjustment.

What is claimed is:

1. A buckle assembly for a stirrup strap, comprising:
a plate connectable to a first end of the stirrup strap, the plate having a tongue extendable from the first end of the stirrup strap when the plate is connected to the stirrup strap, the tongue having a first side and a second side with at least one pin extending perpendicularly from the first side, the pin being insertable in a least one of a plurality of through-holes extending through the stirrup strap near a second end thereof; and
a receiver having a sleeve with a first side and a second side, the sleeve being configured to slidably receive the second end of the stirrup strap and the tongue when the pin of the first side of the tongue is positioned in one of the through-holes of the stirrup strap, the receiver further having a spring latch with a proximal end and a distal end, the distal end having an opening for receiving the pin of the tongue, the spring latch extending from the sleeve in a way that the spring latch is moveable between a locking position wherein the distal end of the spring latch is biased to receive the pin of the first side of the tongue in the opening of the spring latch when the pin of the tongue is inserted in one of the through-holes and a release position wherein the distal end is deflected away from the pin to permit the receiver to slide relative to the tongue.

2. A stirrup strap, comprising:
a strap having a first end and a second end, the second end having a plurality of through-holes; and
a buckle assembly, comprising:
a plate connected to the first end of the strap, the plate having a tongue extending from the first end of the strap, the tongue having a first side and a second side with at least one pin extending perpendicularly from the first side, the pin being insertable in a least one of a plurality of through-holes of the strap; and
a receiver having a sleeve with a first side and a second side, the sleeve being configured to slideably receive the second end of the strap and the tongue when the pin of the first side of the tongue is positioned in one of the through-holes of the strap, the receiver further having a spring latch with a proximal end and a distal end, the distal end having an opening for receiving the pin of the tongue, the spring latch extending from the sleeve in a way that the spring latch is moveable between a locking position wherein the distal end of the spring latch is biased to receive the pin of the first side of the tongue in the opening of the spring latch when the pin of the tongue is inserted in one of the through-holes and a release position wherein the distal end is deflected away from the pin to permit the receiver to slide relative to the tongue.

3. A buckle assembly for a stirrup strap, comprising:
a plate connectable to a first end of the stirrup strap, the plate having a tongue extendable from the first end of the stirrup strap when the plate is connected to the stirrup strap, the tongue having a first side and a second side with at least one pin extending perpendicularly from the first side and at least one pin extending perpendicularly from the second side, the pin of the first side being insertable in a least one of a plurality of through-holes extending through the stirrup strap near a second end thereof; and
a receiver having a sleeve with a first side and a second side, the sleeve being configured to slideably receive the second end of the stirrup strap and the tongue when the pin of the first side of the tongue is positioned in one of the through-holes of the stirrup strap, the receiver further having a spring latch with a proximal end and a distal end, the distal end having an opening for receiving the pin of the second side of the tongue, the spring latch extending from the sleeve in a way that the spring latch is moveable between a locking position wherein the distal end of the spring latch is biased to receive the pin of the second side of the tongue when the pin of the first side is inserted in one of the through-holes and a release position wherein the distal end is deflected away from the pin of the second side so as to permit the receiver to slide relative to the tongue.

4. A stirrup strap, comprising:
a strap having a first end and a second end, the second end having a plurality of through-holes; and
a buckle assembly, comprising:
a plate connected to the first end of the strap, the plate having a tongue extending from the first end of the strap, the tongue having a first side and a second side with at least one pin extending perpendicularly from the first side and at least one pin extending perpendicularly from the second side, the pin of the first side being insertable in a least one of a plurality of through-holes extending through the strap; and
a receiver having a sleeve with a first side and a second side, the sleeve being configured to slideably receive the second end of the stirrup strap and the tongue when the pin of the first side of the tongue is positioned in one of the through-holes of the strap, the receiver further having a spring latch with a proximal end and a distal end, the distal end having an opening for receiving the pin of the second side of the tongue, the spring latch extending from the sleeve in a way that the spring latch is moveable between a locking position wherein the distal end of the spring latch is biased to receive the pin of the second side of the tongue when the pin of the first side is inserted in one of the through-holes and a release position wherein the distal end is deflected away from the pin of the second side so as to permit the receiver to slide relative to the tongue.

5. A buckle assembly for a stirrup strap, comprising:
a plate connectable to a first end of the stirrup strap, the plate having a tongue extendable from the first end of the stirrup strap when the plate is connected to the stirrup strap, the tongue having a first side and a second side with at least one pin extending perpendicularly from the first side, the pin being insertable in a least one of a plurality of through-holes extending through the stirrup strap near a second end thereof; and
a receiver having a sleeve with a first side and a second side, the sleeve being configured to slidably receive the second end of the stirrup strap and the tongue when the pin of the first side of the tongue is positioned in one of the through-holes of the stirrup strap, the receiver further having a spring latch with a proximal end and a distal end, the distal end having a barb extending substantially perpendicularly from the spring latch, the spring latch extending from the sleeve in a way that the spring latch is moveable between a locking position wherein the distal end of the spring latch is biased to position the barb between the pin and a side of the through-hole when the pin is inserted in one of the through-holes and a release position wherein the distal end and barb are deflected away from the pin to permit the receiver to slide relative to the tongue.

6. A stirrup strap, comprising:
a strap having a first end and a second end, the second end having a plurality of through-holes; and
a buckle assembly, comprising:
a plate connected to the first end of the strap, the plate having a tongue extending from the first end of the strap, the tongue having a first side and a second side with at least one pin extending perpendicularly from the first side, the pin being insertable in a least one of a plurality of through-holes of the strap; and
a receiver having a sleeve with a first side and a second side, the sleeve being configured to slideably receive the second end of the strap and the tongue when the pin of the first side of the tongue is positioned in one of the through-holes of the strap, the receiver further having a spring latch with a proximal end and a distal end, the distal end having a barb extending substantially perpendicularly from the spring latch, the spring latch extending from the sleeve in a way that the spring latch is moveable between a locking position wherein the distal end of the spring latch is biased to position the barb between the pin and a side of the through-hole when the pin is inserted in one of the through-holes and a release position wherein the distal end and barb are deflected away from the pin to permit the receiver to slide relative to the tongue.

7. A buckle for a stirrup strap, the stirrup strap having a plate connected to a first end of the stirrup strap, the plate having a tongue extending from the first end of the stirrup strap, the tongue having a first side and a second side with at least one pin extending perpendicularly from the first side, the pin being insertable in a least one of a plurality of through-holes extending through the stirrup strap near a second end thereof, the buckle comprising:
a sleeve with a first side and a second side, the sleeve being configured to slidably receive the second end of the stirrup strap and the tongue of the plate when the pin of the first side of the tongue is positioned in one of the through-holes of the stirrup strap, and a spring latch having a proximal end and a distal end, the spring latch extending from the sleeve in a way that the spring latch is moveable between a locking position wherein the distal end of the spring latch is biased to engage the stirrup strap and a release position wherein the distal end is deflected away from the stirrup strap to permit the sleeve to slide relative to the tongue.

8. The buckle of claim 7, wherein the distal end of the spring latch has a barb extending substantially perpendicularly from the spring latch such that in the locking position the barb is positionable between the pin and a side of the through-hole of the stirrup strap when the pin is inserted in one of the through-holes and in the release position the distal end and barb are deflected away from the pin to permit the sleeve to slide relative to the tongue.

9. The buckle of claim 7, wherein the distal end of the spring latch of the receiver has an opening for receiving the pin of the second side of the tongue, such that in the locking position the opening of the distal end of the spring latch is biased to receive the pin of the second side of the tongue when the pin of the first side is inserted in one of the through-holes and in the release position the opening of the distal end is deflected away from the pin of the second side so as to permit the sleeve to slide relative to the tongue.

10. The buckle of claim 9, wherein the distal end of the spring latch of the receiver has a barb extending substantially perpendicularly from the spring latch, such that in the locking position the barb is positionable between the pin and a side of the through-hole of the stirrup strap when the pin is inserted in one of the through-holes and in the release position the distal end and barb are deflected away from the pin to permit the sleeve to slide relative to the tongue.
